(19) United States
(12) Patent Application Publication
(10) Pub. No.: US 2025/0097750 A1
(43) Pub. Date: Mar. 20, 2025

(54) INFORMATION PROCESSING METHODS AND APPARATUSES, AND COMMUNICATION DEVICE AND STORAGE MEDIUM

(71) Applicant: Beijing Xiaomi Mobile Software Co., Ltd., Beijing (CN)

(72) Inventor: Xuhua TAO, Beijing (CN)

(21) Appl. No.: 18/727,628

(22) PCT Filed: Jan. 11, 2022
(86) PCT No.: PCT/CN2022/071419

§ 371 Date: Jul. 9, 2024

(51) Int. Cl. H04W 24/10; H04W 72/044

(52) U.S. Cl. CPC H04W 24/10; H04W 72/044

(57) ABSTRACT

A method and apparatuses for processing information, a communication device and a storage medium. The method is performed by a base station and includes transmitting a measurement configuration of a shared measurement gap, where the measurement configuration includes first indication information, where the first indication information indicates a measurement duration ratio of a plurality of non-intra-frequency carriers.

### CROSS-REFERENCE

The present application is a U.S. National Stage of International Application No. PCT/CN2022/071419, filed on Jan. 11, 2022, the contents of all of which are incorporated herein by reference in their entireties for all purposes.

### BACKGROUND OF THE INVENTION

In a radio resource control (RRC) connected state, a plurality of measurement objects (MOs) will be configured to share a measurement gap by a network.

The measurement gap shared by a plurality of MOs can be referred to as a shared measurement gap.

If user equipment (UE) needs to measure a plurality of MOs in a shared measurement gap, how the UE performs specific measurement remains to be further studied.

### SUMMARY OF THE INVENTION

A method and apparatus for processing information, a communication device, and a storage medium are provided in examples of the disclosure.

In a first aspect, a method for processing information is provided in an example of the disclosure. The method is performed by a base station and includes:
transmitting a measurement configuration of a shared measurement gap, where the measurement configuration includes: at least first indication information; and
the first indication information indicates a measurement duration ratio of a plurality of non-intra-frequency carriers.

In a second aspect, a method for processing information is provided in an example of the disclosure. The method is performed by user equipment (UE) and includes:
receiving a measurement configuration of a shared measurement gap, where the measurement configuration includes: at least first indication information; and
the first indication information indicates a measurement duration ratio of a plurality of non-intra-frequency carriers.

In a third aspect, a communication device is provided in an example of the disclosure. The communication device includes a processor, a transceiver, a memory, and an executable program stored on the memory and runnable by the processor, where the processor, when running the executable program, executes following steps of:
transmitting a measurement configuration of a shared measurement gap, where the measurement configuration includes: at least first indication information; and
the first indication information indicates a measurement duration ratio of a plurality of non-intra-frequency carriers.

In a fourth aspect, a communication device is provided in an example of the disclosure. The communication device includes a processor, a transceiver, a memory, and an executable program stored on the memory and runnable by the processor, where the processor executes the method for processing information in the second aspect when running the executable program.

In a fifth aspect, a computer storage medium is provided in an example of the disclosure. The computer storage medium stores an executable program, where the executable program implements the method for processing information in the first aspect after being performed by a processor.

In a sixth aspect, a computer storage medium is provided in an example of the disclosure. The computer storage medium stores an executable program, where the executable program implements the method for processing information in the second aspect after being performed by a processor.

### BRIEF DESCRIPTION OF DRAWINGS

The accompanying drawings here are incorporated in the description as a constituent part of the description, illustrate examples conforming to the disclosure, and serve to explain the principles of the examples of the disclosure along with the description.

FIG. 1 is a schematic structural diagram of a radio communication system shown according to an example;

FIG. 2 is a schematic flowchart of a method for processing information shown according to an example;

FIG. 3A is a schematic diagram of a shared measurement gap shown according to an example;

FIG. 3B is a schematic diagram of a shared measurement gap shown according to an example;

FIG. 4A is a schematic flowchart of a method for processing information shown according to an example;

FIG. 4B is a schematic flowchart of a method for processing information shown according to an example;

FIG. 5 is a schematic flowchart of a method for processing information shown according to an example;

FIG. 6 is a schematic flowchart of a method for processing information shown according to an example;

FIG. 7 is a schematic structural diagram of an apparatus for processing information shown according to an example;

FIG. 8 is a schematic structural diagram of an apparatus for processing information shown according to an example;

FIG. 9 is a schematic structural diagram of user equipment (UE) shown according to an example; and

FIG. 10 is a schematic structural diagram of a communication device shown according to an example.

### DETAILED DESCRIPTION OF THE INVENTION

Examples will be described in detail here and are illustratively shown in the accompanying drawings. When the following description relates to the accompanying drawings, the same numbers in different accompanying drawings denote the same or similar elements, unless indicated otherwise. Embodiments described in the following examples do not represent all embodiments consistent with the examples of the disclosure. Rather, the embodiments are merely instances of apparatus and methods consistent with some aspects of the examples of the disclosure as recited in detail in the appended claims.

The terms used in the examples of the disclosure are merely to describe the specific examples, instead of limiting the examples of the disclosure. The singular forms such as “a”, “an”, and “the” used in the examples of the disclosure and the appended claims are also intended to include the plural forms, unless clearly stated in the context otherwise. It should also be understood that the term “and/or” used here means and encompasses one or any or all possible combinations of a plurality of associated items listed.

It should be understood that while the terms first, second, third, etc. may be employed in the examples of the disclosure to describe various information, these pieces of information should not be limited to this. These terms are merely used to distinguish between the same type of information. For example, first information can also be referred to as second information, and similarly, second information can also be referred to as first information, without departing from the scope of the examples of the disclosure. The word “if” as used here can be interpreted as “at the time of”, “when”, or “in response to determining”, depending on the context.

The disclosure relates to the technical field of radio communication, but is not limited to the technical field of radio communication, and in particular to a method and apparatus for processing information, a communication device, and a storage medium.

In the technical solutions according to the examples of the disclosure, the measurement configuration transmitted by the base station encompasses the first indication information, and the first indication information indicates how to allocate the shared measurement gap among the plurality of non-intra-frequency carriers. The measurement confusion of the UE and/or failure of the UE to measure the non-intra-frequency carriers that the base station prefers the UE to measure, caused by the lack of constraint on the measurement duration ratio of the UE for the shared measurement gap before the plurality of non-intra-frequency carriers, is reduced. Thus, an undesirable load balance effect or service communication quality is avoided. Accordingly, the technical solutions according to the examples of the disclosure improve a radio communication quality. It should be understood that the above general description and the following detailed description are merely illustrative and explanatory and cannot limit the examples of the disclosure.

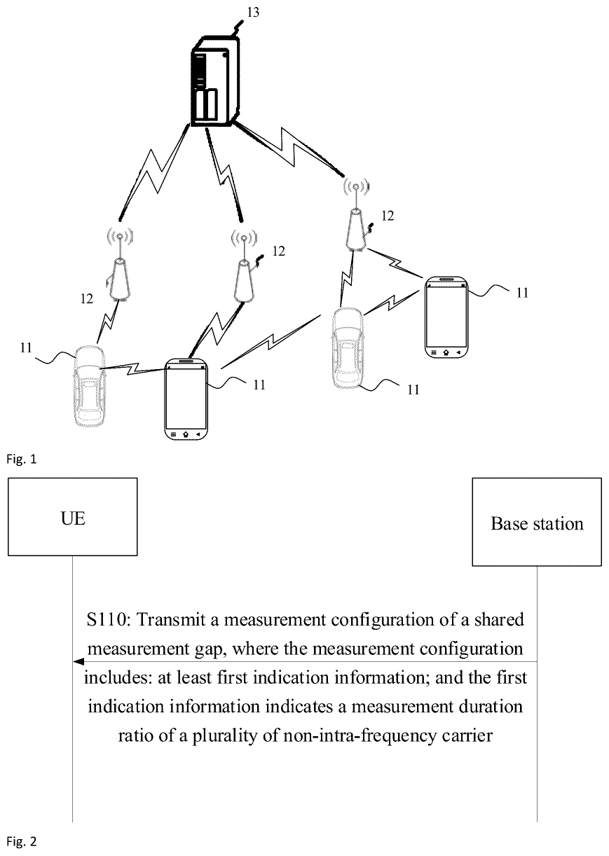

With reference to FIG. 1, a schematic structural diagram of a radio communication system according to an example of the disclosure is shown. As shown in FIG. 1, the radio communication system is a communication system based on cellular mobile communication and may include: several pieces of user equipment (UE) 11 and several access devices 12.

The UE 11 may be a device providing voice and/or data connectivity for a user. The UE 11 may communicate with one or more core networks via a radio access network (RAN). The UE 11 may be Internet of Things UE, such as a sensor device, a mobile phone (or referred to as a “cellular” phone), and a computer with Internet of Things UE, for example, a stationary, portable, pocket, handheld, intra-computer, or vehicle-mounted apparatus. For example, the UE 11 may also be a station (STA), a subscriber unit, a subscriber station, a mobile station, a mobile, a remote station, an access point, a remote terminal, an access terminal, a user terminal, a user agent, a user device, or user equipment (UE). Alternatively, the UE 11 may also be an unmanned aerial vehicle. Alternatively, the UE 11 may also be a vehicle-mounted device, for example, an electronic control unit having a radio communication function, or a radio communication device externally connected to the electronic control unit. Alternatively, the UE 11 may also be a roadside device, for example, a street lamp, a signal lamp, etc. having a radio communication function.

The access device 12 may be a network side device in the radio communication system. The radio communication system may be a 4th generation mobile communication (4G) system, which is also referred to as a long term evolution (LTE) system. Alternatively, the radio communication system may also be a 5th generation mobile communication (5G) system, which is also referred to as a new radio (NR) system or a 5G NR system. Alternatively, the radio communication system may also be a next generation system following the 5G system. An access network in the 5G system may be referred to a new generation-radio access network (NG-RAN), or a machine-type communication (MTC) system.

The access device 12 may be an evolved node B (eNB) employed in the 4G system. Alternatively, the access device 12 may also be a next generation node B (gNB) employing a central-distributed architecture in the 5G system. When employing the central-distributed architecture, the access device 12 typically includes a central unit (CU) and at least two distributed units (DUs). The central unit is provided with a protocol stack of a packet data convergence protocol (PDCP) layer, a radio link control (RLC) layer, and a media access control (MAC) layer. Each distributed unit is provided with a protocol stack of a physical (PHY) layer. Particular embodiments of the access device 12 are not limited in the examples of the disclosure.

The access device 12 is in radio connection to the UE 11 through a wireless radio. In different embodiments, the wireless radio is a wireless radio based on a standard of the 4th generation mobile communication (4G) or a standard of the 5th generation mobile communication (5G), and is a new radio, for example. Alternatively, the wireless radio may also be a wireless radio based on a standard of next generation mobile communication following 5G.

In some examples, an end to end (E2E) connection may also be constructed between the UE 11. For example, scenarios such as vehicle to vehicle (V2V) communication, vehicle to infrastructure (V2I) communication, and vehicle to pedestrian (V2P) communication in vehicle to everything (V2X) communication are provided.

In some examples, the radio communication system above may further encompass a network management device 13.

Several access devices 12 are individually connected to the network management device 13. The network management device 13 may be a core network device in the radio communication system. For example, the network management device 13 may be a mobility management entity (MME) in an evolved packet core (EPC). Alternatively, the network management device may also be another core network device, such as a serving gateway (SGW), a public data network gateway (PGW), a policy and charging rules function (PCRF), and a home subscriber server (HSS). An implementation form of the network management device 13 is not limited in the examples of the disclosure.

As shown in FIG. 2, a method for processing information is provided in an example of the disclosure. The method is performed by a base station and includes S110.

S110: a measurement configuration of a shared measurement gap is transmitted, where the measurement configuration includes: at least first indication information; and
the first indication information indicates a measurement duration ratio of a plurality of non-intra-frequency carriers.

The base station includes, but is not limited to, an evolved node B (eNB) or a next generation node B (gNB).

The measurement configuration may be the measurement configuration of the shared measurement gap. The shared measurement gap is a measurement gap shared by a plurality of measurement objects. The measurement objects include, but are not limited to, a carrier.

The non-intra-frequency carriers related to the first indication information encompassed in the measurement configuration may be any carrier except for intra-frequency carriers.

The first indication information indicates the measurement duration ratio among the plurality of non-intra-frequency carriers. In this way, if the shared measurement configuration includes the plurality of non-intra-frequency carriers, the UE may allocate measurement duration of the plurality of non-intra-frequency carriers according to the first indication information when performing measurement. Accordingly, the measurement of different non-intra-frequency carriers by the UE in the shared measurement gap is accurately controlled.

If the shared measurement gaps are periodically distributed in a time domain, the measurement duration ratio may include: a number ratio of the shared measurement gaps occupied by the non-intra-frequency carriers.

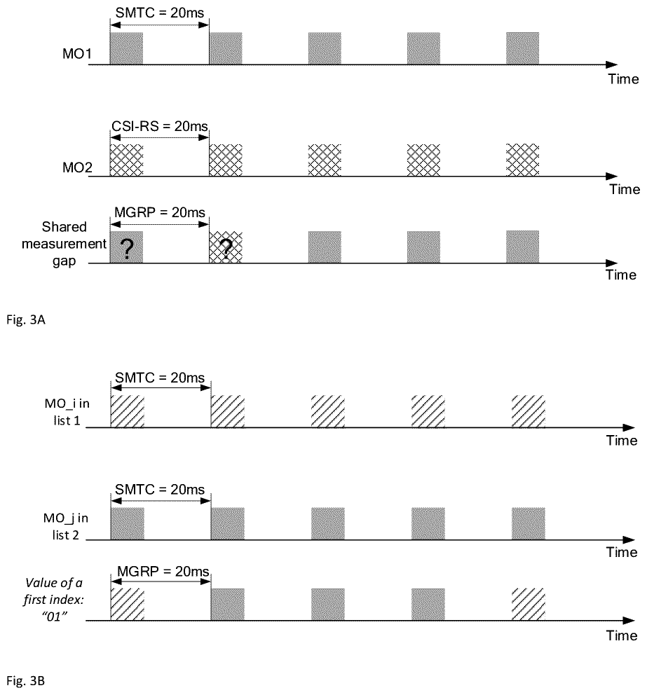

As shown in FIG. 3A, the measurement configuration indicates measurement objects MO1 and MO2 in the same measurement gap (i.e., the shared measurement gap), where MO1 and MO2 here may be any two non-intra-frequency carriers. As shown in FIG. 3A, when a period of the measurement gap is 20 ms, if the plurality of non-intra-frequency carriers share the measurement gap, the UE is confused with or unconscious of the carrier to be measured in each measurement gap timing. If there is no indication of the first indication information, as shown in FIG. 3A, the UE is unclear about whether to measure MO1 or MO2 in the shared measurement gap, which may cause measurement confusion. MO1 in FIG. 3A may be a carrier of a synchronization signal block. Thus, the measurement gap is a synchronization signal block based radio resource management measurement timing configuration (SMTC). MO2 may include: a carrier of a reference signal (RS) for channel state information. A measurement gap repetition period (MGRP) of the shared measurement gap is shown in FIG. 3A.

If the base station transmits the first indication information to the UE, according to the first indication information encompassing first indexes, as shown in FIG. 3B, the time to measure MO_i and MO_j and respective measurement duration of MO_i and MO_j are determined according to a measurement duration ratio of MO_i to MO_j in the shared measurement gap. The first indexes shown in FIG. 3B may be a kind of first indication information, but is not limited to the first indexes shown in FIG. 3B.

In an example, the non-intra-frequency carriers include: at least inter-frequency carriers, inter-Radio Access Technology (RAT) carriers, and/or carriers of different reference signals.

Illustratively, the non-intra-frequency carriers include, but are not limited to, inter-frequency carriers, a plurality of inter-RAT carriers, and/or carriers of other reference signals except for a reference signal currently measured by the UE.

For example, current serving carrier of the UE, a new radio (NR) carrier, carriers having the different center frequency as the current serving carrier of the UE, and/or carriers having the same center frequency as the current serving carrier but having different sub carrier spaces (SCSs), are all the inter-frequency carriers of the UE. In this case, a long term evolution (LTE) carrier is an inter-RAT carrier of the current serving carrier of the UE. For example, if the reference signal currently measured by the UE is a carrier of a positioning reference signal (PRS), the carrier of the reference signal (RS) of the channel state information is a carrier of different reference signals.

In an example, the first indication information includes: first indexes, and one of the first indexes has a correspondence relation with a plurality of ratios; a ratio occupied by one carrier group is a ratio of measurement duration of the carrier group to measurement duration of the non-intra-frequency carriers;

the measurement duration of the non-intra-frequency carriers is duration of the shared measurement gap or remaining duration obtained by subtracting measurement duration of intra-frequency carriers from the duration of the shared measurement gap; and one carrier group includes one or more carriers.

Illustratively, one carrier group encompasses at least one carrier, and the carriers encompassed in one carrier group include the intra-frequency carriers and/or the non-intra-frequency carriers.

The ratio occupied by one carrier group here is the ratio of the measurement duration of the carrier group to the measurement duration of the non-intra-frequency carriers, and may include:
the ratio occupied by one carrier group is a ratio of the measurement duration of the carrier group to measurement duration of all the non-intra-frequency carrier groups;
or,
the ratio occupied by one carrier group is a ratio of the measurement duration of the carrier group to measurement duration of all carrier groups.

Whether the ratio occupied by one carrier group corresponds to the ratio relative to the measurement duration of the non-intra-frequency carriers or the ratio relative to duration of an entire shared measurement gap is related to a type of the shared measurement gap.

The shared measurement gap may be classified into a plurality of types according to relations between objects sharing the shared measurement gap. Owing to different types of shared measurement gaps, measurement duration allocated to the non-intra-frequency carriers may be different.

Thus, in an example, the measurement duration occupied by one carrier group is determined according to the ratio of the carrier group, the type of the shared measurement gap, and the duration of the shared measurement gap.

Thus, in the example of the disclosure, reference is made to the type of the shared measurement gap when the measurement duration of each carrier group is determined according to the ratio indicated by the first index. In other words, the first indexes and the ratios indicated by the first indexes may used for duration allocation of different types of shared measurement gaps, which has various application scenarios.

Illustratively, the type of the shared measurement gap includes:
a first-type shared measurement gap shared by the plurality of non-intra-frequency carriers;
and/or,
a second-type shared measurement gap shared by the at least one intra-frequency carrier and the at least one non-intra-frequency carrier.

In other words, the first-type shared measurement gap is equivalent to a measurement gap configured for the non-intra-frequency carrier only.

The second-type shared measurement gap is measurement gap in which the intra-frequency carriers and the non-intra-frequency carriers are required to be measured simultaneously.

The type of the shared measurement gap may be explicitly or implicitly indicated by the measurement configuration. For example, the measurement configuration has a type indication. The function indication may have one or more bits, indicating the type of the shared measurement gap.

In some other examples, if the shared measurement gap is the second-type shared measurement gap, the measurement configuration may further include: second indication information indicating a measurement duration ratio of the intra-frequency carriers to the non-intra-frequency carrier. In this case, whether the measurement configuration carries the second indication information may implicitly indicate the type of the shared measurement gap. For example, if the measurement configuration carries the second indication information, the shared measurement gap is deemed as the second-type shared measurement gap, otherwise the shared measurement gap is deemed as the first-type shared measurement gap.

In an example, the measurement duration occupied by one carrier group equals a product of the ratio occupied by the carrier group and the duration of the shared measurement gap, in response to determining that the shared measurement gap is the first-type shared measurement gap.

In another example, the measurement duration occupied by one carrier group equals a product of the ratio occupied by the carrier group and the measurement duration of the non-intra-frequency carriers, in response to determining that the shared measurement gap is the second-type shared measurement gap. The measurement duration of the non-intra-frequency carriers is remaining duration obtained by subtracting the measurement duration of the intra-frequency carriers from the duration of the shared measurement gap.

When the shared measurement gap is the first-type shared measurement gap, and the measurement objects are all the non-intra-frequency carriers, the measurement duration may be allocated from total duration of the shared measurement gap according to the ratio occupied by the carrier group of the non-intra-frequency carriers.

When the shared measurement gap is the second-type shared measurement gap, and the measurement object encompasses the intra-frequency carriers and the non-intra-frequency carriers, measurement of the intra-frequency carriers needs to be pre-considered. Thus, the measurement duration of the non-intra-frequency carriers is obtained after preferentially reserving the measurement duration of the intra-frequency carriers from the shared measurement gap. The measurement duration is determined in combination with the ratio occupied by the carrier group of the non-intra-frequency carriers to be measured.

In an example, the carrier group includes at least one of the following:
a non-intra-frequency carrier group including one or more non-intra-frequency carriers;
an intra-frequency carrier group including the intra-frequency carriers; or
a hybrid carrier group including at least one intra-frequency carrier and at least one non-intra-frequency carrier.

The carriers encompassed in the non-intra-frequency carrier group are non-intra-frequency carriers relative to a carrier currently used by the UE, for example, inter-frequency carriers, inter-RAT carriers, and/or carriers of other reference signals relative to the carrier currently used by the UE.

The intra-frequency carrier group includes one carrier, which is the carrier currently used by the UE.

The hybrid carrier group encompasses the intra-frequency carriers and the non-intra-frequency carriers.

In an example, in response to determining that a plurality of carriers of one carrier group are required to be measured, measurement duration determined according to the ratio occupied by the carrier group is shared by the plurality of carriers of the same carrier group.

Illustratively, in response to determining that a plurality of non-intra-frequency carriers of one of the non-intra-frequency carrier groups are required to be measured, measurement duration determined according to the ratio occupied by the non-intra-frequency carrier group is shared by the plurality of non-intra-frequency carriers of the same non-intra-frequency carrier group.

The measurement duration determined according to the ratio occupied by the carrier group may be equally allocated to the plurality of non-intra-frequency carriers of the same carrier group. Alternatively, the measurement duration determined according to the ratio occupied by the carrier group may be allocated according to a preset proportion or may be allocated by the UE randomly.

The first indexes include one or more bits, and different bit values of the first indexes have correspondence relations with different ratios.

TABLE 1

| First indexes | | | | |
|---|---|---|---|---|
| (measGapSharingIndex) | Ratio A (%) | Ratio B (%) | Ratio C (%) | . . . |
| ‘00’ | 50 | 30 | 20 | . . . |
| ‘01’ | 60 | 30 | 10 | . . . |
| ‘10’ | 70 | 20 | 10 | . . . |
| ‘11’ | 80 | 15 | 5 | . . . |

In Table 1, the first index includes two bits, and index values of the first index are different because the two bits are set to different values. Ratios corresponding to the first index having different index values are different. For example, if the first index is set to ‘00’, ratios indicated are 50%, 30%, and 20% respectively. Measurement duration of a non-intra-frequency carrier group corresponding to ratio A is 50% of the measurement duration occupied by all the non-intra-frequency carriers. Measurement duration of a non-intra-frequency carrier group corresponding to ratio B is 30% of the measurement duration occupied by all the non-intra-frequency carriers. Measurement duration of a non-intra-frequency carrier group corresponding to ratio C is 20% of the measurement duration occupied by all the non-intra-frequency carriers.

If the shared measurement gap is the first-type shared measurement gap here, the duration of all the non-intra-frequency carriers is the duration of the shared measurement gap. If the shared measurement gap is the second-type shared measurement gap, the measurement duration of all the non-intra-frequency carriers is the measurement duration of the non-intra-frequency carriers.

Illustratively, assuming that all the non-intra-frequency carriers are divided into three carrier groups, where A denotes a ratio of measurement duration of carrier group 3 to the measurement duration of all the non-intra-frequency carriers. B denotes a ratio of measurement duration of carrier group 2 to the measurement duration of all the non-intra-frequency carriers. C denotes a ratio of measurement duration of carrier group 1 to the measurement duration of all the non-intra-frequency carriers.

If the non-intra-frequency carriers to be measured by the UE currently are from carrier group 1 and carrier group 3, and the index value of the first index is 10, measurement duration of one or more non-intra-frequency carriers to be measured are from carrier group 1 accounts for 10% of the measurement duration occupied by all the non-intra-frequency carriers, and measurement duration of one or more non-intra-frequency carriers to be measured are from carrier group 3 accounts for 80% of the measurement duration occupied by all the non-intra-frequency carriers.

Ratio A, ratio B, and ratio C correspond to the ratios occupied by different carrier groups respectively. If one carrier group encompasses a plurality of carriers, all carriers in the carrier group share the ratio. For example, when carrier group A encompasses two carriers a and b, and a ratio occupied by carrier group A is 50%, carrier a and carrier b share the ratio 50%, and a ratio of carrier a to carrier b may be allocated by the UE flexibly.

For example, if the shared measurement gap is a shared measurement gap of the non-intra-frequency carriers, the duration, occupied by the corresponding carrier group, in the shared measurement gap is a product of the ratio indicated by the first index and the duration of the shared measurement gap.

Further illustratively, if the shared measurement gap is a shared measurement gap of the intra-frequency carriers and the non-intra-frequency carriers, the duration, occupied by the corresponding carrier group, in the shared measurement gap is a product of the ratio indicated by the first index and the measurement duration of the non-intra-frequency carriers. The measurement duration of the non-intra-frequency carriers here is remaining duration obtained by subtracting the measurement duration occupied by the intra-frequency carriers from the duration of the shared measurement gap.

As shown in FIG. 3B, a carrier identifier of one carrier group is encompassed in a list. In other words, different lists correspond to different carrier groups. For example, MO_j is encompassed in list 2. MO_i is encompassed in list 1. A carrier group formed by carriers in list 1 corresponds to value B, and a carrier group formed by carriers in list 2 corresponds to value A. Assuming that the index value of the first index is “01” (with reference to the ratio allocation of the measurement gap duration of the carrier group in Table 1), when the shared measurement gap is allocated, duration for the UE to measure MO_j accounts for 60% of the entire shared measurement gap, and duration for measuring MO_i accounts for 40% of the entire shared measurement gap. In other words, within 5 shared measurement gaps, MO_j occupies 3 shared measurement gaps and MO_i occupies only 2 shared measurement gaps.

In some examples, the correspondence relation between the first index and the plurality of ratios may be agreed in a protocol.

In some other examples, the correspondence relation between the first index and the plurality of ratios may be pre-configured by a network device. For example, the base station pre-broadcasts the correspondence relation through RRC signaling. The network device includes: the base station and/or the core network device, or a network management device of the base station, etc.

The correspondence relation may be configured according to at least one of the following methods:
the correspondence relation is configured according to a load ratio and a load balance strategy of each non-intra-frequency carrier;
the correspondence relation is configured according to a drainage strategy; or
the correspondence relation is configured according to a service demand.

When the correspondence relation is configured according to the load balance strategy, a non-intra-frequency carrier having a lower load rate may have a higher ratio. Thus, load balance between different carriers is realized by enabling the UE to measure more carriers having a lower load rate and hand over the serving carrier to the non-intra-frequency carrier having a lower load rate.

For example, there are 4G carriers and 5G carriers in the mobile communication system. More UE will be guided to use the 5G carriers, in order to make the UE have a better communication quality. In this case, a higher ratio may be configured for the 5G carriers according to the drainage strategy.

For another example, when an abnormality occurs in a 5G base station in a certain area, the more UE is guided to use the 4G carriers according to the drainage strategy, and a greater ratio may be configured for the 4G carriers according to the correspondence relation between the first index and the ratio of the non-intra-frequency carriers.

In some examples, the UE has a positioning service and needs to use the positioning reference signal. Thus, a ratio of the carriers of the positioning reference signal may be determined in consideration of measurement demands of the positioning service.

In conclusion, the correspondence relation may be dynamically configured by the network device according to current communication conditions.

In some examples, the shared measurement gap is the second-type shared measurement gap shared by the intra-frequency carriers and the non-intra-frequency carriers, and the measurement configuration further includes: second indication information. The second indication information may further include:
second indexes indicating a first ratio of the measurement duration of the intra-frequency carriers to the shared measurement gap; and
a sum of a second ratio and the first ratio is 1, and the second ratio is a ratio of the measurement duration of the non-intra-frequency carriers to the shared measurement gap.

The second indexed and the first indexed here are carried by different fields. For example, the second indexes may be indicated by one or more bits.

A measurement sequence of the plurality of non-intra-frequency carriers may be determined by the UE itself. Illustratively, the UE may randomly determine the measurement sequence of the plurality of non-intra-frequency carriers. Alternatively, the UE may perform measurement ranking according to sequence numbers of the non-intra-frequency carriers in a descending or ascending order.

Reference may be made to the related art for a method for the UE to determine the measurement order of the plurality of non-intra-frequency carriers, which will not be described in detail here.

TABLE 2

| Second indexes | |
|---|---|
| (measGapSharingScheme) | Ratio X (%) |
| ‘00’ | Equal allocation |
| ‘01’ | 25 |
| ‘10’ | 50 |
| ‘11’ | 75 |

X % denotes the first ratio.

The second ratio is the ratio of the measurement duration of all the non-intra-frequency carriers to the shared measurement gap. Since a sum of the first ratio and the second ratio is 100%, the UE may determine the second ratio according to the first ratio after the second index has indicated the first ratio.

In this case, (1−X %)*T denotes total measurement duration occupied by the plurality of non-intra-frequency carriers in one shared measurement gap. T denotes the total duration of the shared measurement gap. For the measurement duration ratio of the plurality of non-intra-frequency carriers, (1−X %)*T is allocated according to the first indication information. (1−X %)*T here is an instance of the measurement duration of the non-intra-frequency carriers.

Thus, in some examples, if the shared measurement gap is the measurement gap of the intra-frequency carriers and the non-intra-frequency carriers, the measurement configuration carries two indication information: the first indication information and the second indication information. If the shared measurement gap is the measurement gap of the plurality of non-intra-frequency carriers, the configuration measurement carries the first indication information only.

In another example, the first indication information has two types. One is a single index, such as the index shown in Table 1, which is merely configured to indicate the measurement duration ratio of the plurality of non-intra-frequency carriers. The other is a composite index, which indicates the measurement duration ratio of the plurality of non-intra-frequency carriers and the duration ratio of the intra-frequency carriers to the non-intra-frequency carriers at the same time. For example, the composite index is set to 01. It can be seen from Tables 1 and 2 that in the shared measurement gap, the duration configured for the intra-frequency carriers is 25%*T, the total measurement duration configured for the non-intra-frequency carriers is 75%*T, and the measurement duration 75%*T is further allocated according to 60%, 30%, or 10% when the plurality of non-intra-frequency carriers are measured. The bit overhead of the measurement configuration may be saved on if the composite index is employed.

In some examples, the intra-frequency carriers and the non-intra-frequency carriers are not distinguished from each other when the UE measures the carriers. In this case, the first indication information includes: third indexes, and one of the third indexes has a correspondence relation with a plurality of ratios.

A ratio occupied by one carrier group is a ratio of measurement duration of the carrier group to the shared measurement gap.

Illustratively, the intra-frequency carriers may form one carrier group separately, which is referred to as the intra-frequency carrier group. The ratios are configured for the intra-frequency carrier group, the non-intra-frequency carrier group, and/or the hybrid carrier group. The measurement duration of the corresponding carrier group is the product of the ratio and the shared measurement gap.

Illustratively, all the carriers are divided into M carrier groups, and the intra-frequency carriers are encompassed in one or more carrier groups. The measurement configuration indicates the ratios occupied by the M carrier groups, and the measurement duration occupied by the corresponding carrier groups may be the products of the ratios and the duration of the shared measurement gap. The ratios occupied by the M carrier groups are indicated by the third indexes.

The third indexes may include one or more bits. If bit values corresponding to the third indexes vary, at least one of the ratios occupied by the M carrier groups is changed. The M carrier groups may be any one or more of the intra-frequency carrier group, the non-intra-frequency carrier group, and/or the hybrid carrier group.

In this case, the measurement duration of all the carriers may be indicated through one piece of first indication information. M may be any positive integer greater than or equal to 2.

In some examples, the measurement configuration may further include at least one of the following:
a gap configuration indicating at least a time domain location of the shared measurement gap; or
a measurement object configuration indicating carriers to be measured.

For example, the gap configuration may include at least one of the following:
a gap length;
a repetition period; or
start and end location offset.

For example, the duration of the shared measurement gap is, for example, 10 s, 20 s, or 24 s.

The repetition period defines a repetition frequency of the shared measurement gap in the time domain.

The start and end location offset is offset relative to a start moment of the repetition period.

In some examples, it is not required to additionally configure the gap length if the gap configuration encompasses the start and end location offset.

Certainly, if no shared measurement gap is periodic, the gap configuration does not include the repetition period.

In conclusion, the gap configuration is configured to determine a distribution location of the shared measurement configuration in the time domain.

The measurement object configuration includes, but is not limited to, a carrier index. The carrier index indicates the carriers to be measured. The carriers to be measured include, but are not limited to, the intra-frequency carriers and/or the non-intra-frequency carriers.

For example, there are two non-intra-frequency carriers, where carrier x is from the carrier group corresponding to ratio A in Table 1, and carrier y is from the carrier group corresponding to ratio C in Table 1. If the current shared measurement gap is the shared measurement gap of the plurality of non-intra-frequency carriers, and the index value of the first index is “11”, duration for the UE to measure carrier x accounts for 80% of the entire shared measurement gap, and duration to measure carrier y accounts for 5% of the entire shared measurement gap.

Further illustratively, there are 3 non-intra-frequency carriers, where carrier x and carrier z are from the carrier group corresponding to ratio A in Table 1, and carrier y is from the carrier group corresponding to ratio C in Table 1. If the index value of the first index is “11”, duration for the UE to measure carrier x and carrier z accounts for 80% of the entire shared measurement gap, and duration to measure carrier y accounts for 5% of the entire shared measurement gap.

When carrier x and carrier z share 80% of the shared measurement gap, the UE may allocate measurement time between carrier x and carrier z according to a predetermined strategy, such as equal allocation or random allocation.

Illustratively, the plurality of non-intra-frequency carriers of one carrier group may be configured with priorities. When the measurement object includes the plurality of non-intra-frequency carriers from the same carrier group, the measurement duration may be further allocated according to the priorities. The priority is positively correlated with the measurement duration allocated.

In an example, as shown in FIG. 4A, S110 may include S110A.

S110A: radio resource control (RRC) signaling encompassing the measurement configuration is transmitted.

In some other examples, as shown in FIG. 4B, S110 may include S110B.

S110B: a media access control (MAC) control element (CE) encompassing the measurement configuration is transmitted.

For example, when the UE is in an RRC connected state, the UE is informed of the way to measure different carriers in the shared measurement gap after the base station transmits the RRC signaling and/or the MAC CE encompassing the measurement configuration to the UE.

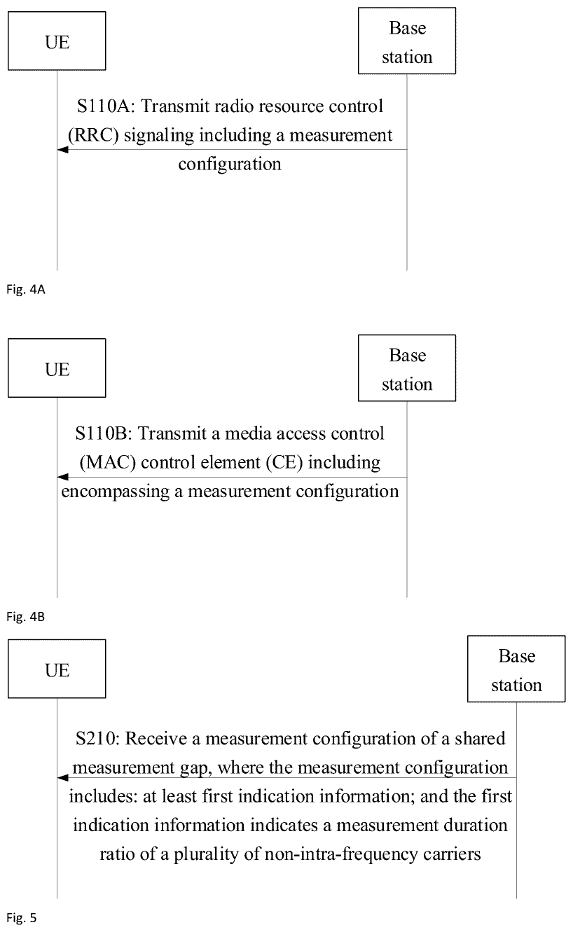

As shown in FIG. 5, a method for processing information is provided according to an example of the disclosure. The method is performed by UE and includes S210.

S210: a measurement configuration of a shared measurement gap is received, where the measurement configuration includes at least: first indication information; where

the first indication information indicates a measurement duration ratio of a plurality of non-intra-frequency carriers.

In an example, the non-intra-frequency carriers include: at least inter-frequency carriers, inter-RAT carriers, and/or carriers of different reference signals.

The UE may receive the measurement configuration in an RRC connected state.

A ratio configured to allocate the shared measurement gap among the plurality of non-intra-frequency carriers different from intra-frequency carriers may be determined according to the measurement configuration. The non-intra-frequency carriers may be the non-intra-frequency carriers relative to a current serving carrier of the UE. The first indication information indicates the way to allocate measurement duration of the shared measurement gap among the plurality of non-intra-frequency carriers.

In this way, the UE may measure the plurality of non-intra-frequency carriers within one shared measurement gap according to the first indication information. Thus, handover of the serving carrier is completed based on a measured value of the carrier in different scenarios, and a communication quality is ensured.

In an example, the first indication information includes:
first indexes, and one of the first indexes has a correspondence relation with a plurality of ratios;
a ratio occupied by one carrier group is a ratio of measurement duration of the carrier group to measurement duration of the non-intra-frequency carriers;
the measurement duration of the non-intra-frequency carriers is duration of the shared measurement gap or remaining duration obtained by subtracting measurement duration of intra-frequency carriers from the duration of the shared measurement gap; and
one carrier group includes one or more carriers.

For different types of shared measurement gaps, the non-intra-frequency carriers have different measurement duration.

Illustratively, the measurement duration occupied by one carrier group is determined according to the ratio, the type of the shared measurement gap, and the duration of the shared measurement gap.

Further, the type of the shared measurement gap includes: a first-type shared measurement gap shared by the plurality of non-intra-frequency carriers; and/or a second-type shared measurement gap shared by the at least one intra-frequency carrier and the at least one non-intra-frequency carrier.

The measurement duration occupied by one carrier group equals a product of the ratio occupied by the carrier group and the duration of the shared measurement gap in response to determining that the shared measurement gap is the first-type shared measurement gap.

Illustratively, the measurement duration occupied by one carrier group equals a product of the ratio occupied by the carrier group and the measurement duration of the non-intra-frequency carriers in response to determining that the shared measurement gap is the second-type shared measurement gap; and the measurement duration of the non-intra-frequency carriers is remaining duration obtained by subtracting the measurement duration of the intra-frequency carriers from the duration of the shared measurement gap.

In response to determining that a plurality of carriers of one carrier group are required to be measured, the measurement duration determined according to the ratio occupied by the carrier group is shared by the plurality of carriers of the same carrier group.

For example, in response to determining that a plurality of non-intra-frequency carriers of one carrier group are required to be measured, the measurement duration determined according to the ratio occupied by the carrier group is shared by the plurality of non-intra-frequency carriers of the same carrier group.

Illustratively, the measurement duration determined according to the ratio occupied by the carrier group may be equally allocated to the plurality of carriers of the same carrier group. Alternatively, the measurement duration determined according to the ratio occupied by the carrier group may be allocated according to a preset proportion or may be allocated by the UE randomly.

In an example, the carrier group includes at least one of the following:
a non-intra-frequency carrier group including one or more non-intra-frequency carriers;
an intra-frequency carrier group including the intra-frequency carriers; or
a hybrid carrier group including at least one intra-frequency carrier and at least one non-intra-frequency carrier.

The carriers encompassed in the non-intra-frequency carrier group are non-intra-frequency carriers relative to a carrier currently used by the UE, for example, inter-frequency carriers, inter-RAT carriers, and/or carriers of other reference signals relative to the carrier currently used by the UE.

The intra-frequency carrier group includes one carrier, which is the carrier currently used by the UE.

The hybrid carrier group encompasses the intra-frequency carriers and the non-intra-frequency carriers.

The shared measurement gap may be classified into a plurality of types according to relations between objects sharing the shared measurement gap. Owing to different types of shared measurement gaps, measurement duration allocated to the non-intra-frequency carriers may be different.

In an example, the shared measurement gap is the second-type shared measurement gap shared by the intra-frequency carriers and the non-intra-frequency carriers, and the measurement configuration further includes:

second indication information indicating a measurement duration ratio of the intra-frequency carriers to the non-intra-frequency carriers.

The second indication information indicates the measurement duration ratio of the intra-frequency carriers to the non-intra-frequency carriers.

If a network side expects the UE to reside on the intra-frequency carriers for longer duration, the measurement duration, indicated by the second indication information, of the intra-frequency carriers is longer than that of the non-intra-frequency carriers.

If the network side expects the UE to hand over to the non-intra-frequency carriers, the second indication information may indicate that the intra-frequency carriers occupy shorter measurement duration. Accordingly, the UE has longer duration for measuring the inter-frequency carriers, the inter-RAT carriers, or the carriers of different reference signals, so that the UE is handed over to the non-intra-frequency carriers with a higher probability according to the measured value of the carriers.

In some examples, the second indication information includes:
second indexes indicating a first ratio of the measurement duration of the intra-frequency carriers to the shared measurement gap; and a sum of a second ratio and the first ratio is 1, and the second ratio is a ratio of the measurement duration of the non-intra-frequency carriers to the shared measurement gap.

In another example, the first indication information includes: third indexes, and one of the third indexes has a correspondence relation with a plurality of ratios; and a ratio occupied by one carrier group is a ratio of measurement duration of the carrier group to the shared measurement gap.

Illustratively, all the carriers are divided into M carrier groups, and the intra-frequency carriers are encompassed in one or more carrier groups. The measurement configuration indicates the ratios occupied by the M carrier groups, and the measurement duration occupied by the corresponding carrier groups may be the products of the ratios and the duration of the shared measurement gap. In this case, the measurement duration of all the carriers may be indicated through one piece of first indication information. M may be any positive integer greater than or equal to 2. The ratios occupied by the M carrier groups are indicated by the third indexes. The third indexes are a kind of first indication information. Similarly, the third indexes may include one or more bits. Different ratios of the one or more bits indicate different ratios of the M carrier groups.

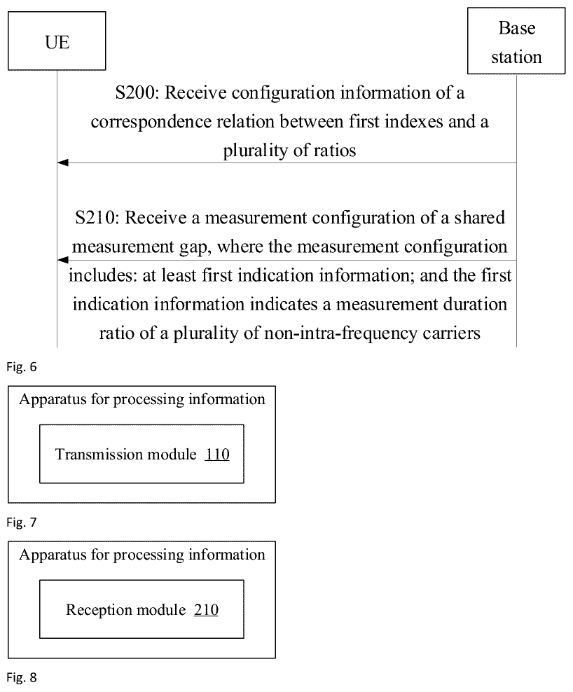

In some examples, as shown in FIG. 6, the method further includes:
S200: configuration information of a correspondence relation between the first indexes and the plurality of ratios is received.

In this way, if the network side expects to update the correspondence relation, the configuration information may be transmitted in broadcast information such as a system message. Certainly, the description here is merely an instance of the configuration information of the correspondence relation, and the configuration information is not limited to the instance during specific implementation.

When the UE is in the RRC connected state, the network may configure a set of measurement gaps to measure a plurality of MOs. The UE may need to measure reference signals of the plurality of MOs in one measurement gap timing, but a way of the UE select to measure the reference signals is uncertain in related art.

A method for scheduling measurement in a shared measurement gap is provided in an example of the disclosure. Accordingly, in one measurement gap timing, if reference signals of MOs in different lists appear simultaneously, the UE may measure the MOs in different lists at different measurement gap timings according to a sharing scheduling mechanism of the shared measurement gap.

A method for measuring a plurality of carriers in a shared measurement gap according to an example of the disclosure may include:

Step 1: a network configures one or more groups of measurement gaps for mobility measurement for UE through RRC signaling.

Step 2: the network configures measurement objects for mobility measurement and correspondence relations between these measurement objects and the measurement gaps for the UE through RRC signaling. For example, measurement gap combination 1 corresponds to several measurement objects, and measurement gap combination 2 corresponds to other measurement objects. Measurement gap combination 1 and measurement gap combination 2 here are any carrier groups above.

Step 3: the network divides measurement objects belonging to the same measurement gap configured in step 1 into X lists and configures same for the UE through RRC;

Step 4: the network configures a measurement gap sharing percentage for the UE through RRC signaling. In other words, in all measurement gap timings, gap percentages configured for the measurement objects in each list are A %, B %, C % . . . respectively, where A %+B %+C %+ . . . =100%.

Step 5: the UE is configured with the measurement timing percentages A %, B %, C % . . . of the measurement gaps in step 3 through network indication. For example, as shown in Table 1, if measGapSharingIndex indicates 00, the ratios corresponding to the first indexes (measGapSharingIndex) having the index value 00 are 50%, 30%, and 20% respectively. Specifically, measGapSharingIndex may be the first indexes above.

A method and system for sharing scheduling of a measurement gap are provided in examples of the disclosure. Accordingly, in a measurement gap timing, if reference signals of MOs in different lists appear simultaneously, the UE may measure MOs in different lists at different measurement gap timings according to a sharing scheduling mechanism of the measurement gap.

As shown in FIG. 7, an apparatus for processing information is provided in an example of the disclosure. The apparatus includes:
a transmission module 110 configured to transmit a measurement configuration of a shared measurement gap, where the measurement configuration includes: at least first indication information; and
the first indication information indicates a measurement duration ratio of a plurality of non-intra-frequency carriers.

The apparatus for processing information may be encompassed in UE.

In some examples, the transmission module 110 may be a program module. The program module enables transmission of the measurement configuration encompassing the first indication information after being executed by a processor.

In another example, the transmission module 110 may be a hardware-software combined module. The hardware-software combined module includes, but is not limited to, various programmable arrays. The programmable arrays include, but are not limited to, field programmable arrays and complex programmable arrays.

In some other examples, the transmission module 110 may be a pure hardware module. The pure hardware module includes, but is not limited to, an application-specific integrated circuit.

In some examples, the non-intra-frequency carriers include at least one of the following:
inter-frequency carriers;
inter-RAT carriers; or
carriers of different reference signals.

In some examples, the first indication information includes:
first indexes, and one of the first indexes has a correspondence relation with a plurality of ratios;
a ratio occupied by one carrier group is a ratio of measurement duration of the carrier group to measurement duration of the non-intra-frequency carriers;
the measurement duration of the non-intra-frequency carriers is duration of the shared measurement gap or remaining duration obtained by subtracting measurement duration of intra-frequency carriers from the duration of the shared measurement gap; and
one carrier group includes one or more carriers.

In an example, the carrier group includes at least one of the following:
a non-intra-frequency carrier group including one or more non-intra-frequency carriers;
an intra-frequency carrier group including the intra-frequency carriers; or
a hybrid carrier group including at least one intra-frequency carrier and at least one non-intra-frequency carrier.

In an example, the measurement duration of one carrier group is determined according to the ratio, a type of the shared measurement gap, and the duration of the shared measurement gap.

Further, the type of the shared measurement gap includes: a first-type shared measurement gap shared by the plurality of non-intra-frequency carriers; and/or a second-type shared measurement gap shared by the at least one intra-frequency carrier and the at least one non-intra-frequency carrier.

Illustratively, the measurement duration occupied by one carrier group equals a product of the ratio occupied by the carrier group and the duration of the shared measurement gap in response to determining that the shared measurement gap is the first-type shared measurement gap.

Illustratively, the measurement duration occupied by one carrier group equals a product of the ratio occupied by the carrier group and the measurement duration of the non-intra-frequency carriers in response to determining that the shared measurement gap is the second-type shared measurement gap; and the measurement duration of the non-intra-frequency carriers is remaining duration obtained by subtracting the measurement duration of the intra-frequency carriers from the duration of the shared measurement gap.

In an example, the measurement duration of one carrier group is determined according to the ratio and the duration of the shared measurement gap. For example, in response to determining that a plurality of non-intra-frequency carriers of one carrier group are required to be measured, the measurement duration determined according to the ratio occupied by the carrier group is shared by the plurality of non-intra-frequency carriers of the same carrier group.

In some examples, the shared measurement gap is the second-type shared measurement gap shared by the intra-frequency carriers and the non-intra-frequency carriers, and the measurement configuration further includes:
second indication information indicating a measurement duration ratio of the intra-frequency carriers to the non-intra-frequency carriers.

In some examples, the second indication information includes:
second indexes indicating a first ratio of the measurement duration of the intra-frequency carriers to the shared measurement gap; and
a sum of a second ratio and the first ratio is 1, and the second ratio is a ratio of the measurement duration of the non-intra-frequency carriers to the shared measurement gap.

The type of one shared measurement gap may be determined according to whether the measurement configuration carries the second indication information. If the measurement configuration carries the second indication information, the shared measurement gap may be determined as the second-type shared measurement gap, otherwise the shared measurement gap may be determined as the first-type shared measurement gap.

In some examples, the first indication information includes: third indexes, and one of the third indexes has a correspondence relation with a plurality of ratios; and a ratio occupied by one carrier group is a ratio of measurement duration of the carrier group to the shared measurement gap.

In some other examples, in response to determining that a plurality of carriers of one carrier group are required to be measured, the measurement duration determined according to the ratio occupied by the carrier group is shared by the plurality of carriers of the same carrier group. For example, in response to determining that a plurality of non-intra-frequency carriers of one of non-intra-frequency carrier groups are required to be measured, the measurement duration determined according to the ratio occupied by the non-intra-frequency carrier group is shared by the plurality of non-intra-frequency carriers of the same non-intra-frequency carrier group.

In some examples, the measurement configuration may further include at least one of the following:
a gap configuration indicating at least a time domain location of the shared measurement gap; or
a measurement object configuration indicating carriers to be measured.

In some examples, the transmission module 110 is configured to transmit radio resource control (RRC) signaling comprising the measurement configuration; or, transmit a media access control (MAC) control element (CE) comprising the measurement configuration.

As shown in FIG. 8, an apparatus for processing information is provided in an example of the disclosure. The apparatus includes:
a reception module 210 configured to receive a measurement configuration of a shared measurement gap, where the measurement configuration includes: at least first indication information; and
the first indication information indicates a measurement duration ratio of a plurality of non-intra-frequency carriers.

In some examples, the reception module 210 may be a program module. The program module enables reception of the measurement configuration encompassing the first indication information after being executed by a processor.

In another example, the reception module 210 may be a hardware-software combined module. The hardware-software combined module includes, but is not limited to, various programmable arrays. The programmable arrays include, but are not limited to, field programmable arrays and complex programmable arrays.

In some other examples, the reception module 210 may be a pure hardware module. The pure hardware module includes, but is not limited to, an application-specific integrated circuit.

In some examples, the non-intra-frequency carriers include at least one of the following:
inter-frequency carriers;
inter-RAT carriers; or
carriers of different reference signals.

In some examples, the first indication information includes:
first indexes, and one of the first indexes has a correspondence relation with a plurality of ratios;
a ratio occupied by one carrier group is a ratio of measurement duration of the carrier group to measurement duration of the non-intra-frequency carriers;
the measurement duration of the non-intra-frequency carriers is duration of the shared measurement gap or remaining duration obtained by subtracting measurement duration of intra-frequency carriers from the duration of the shared measurement gap; and
one carrier group includes one or more carriers. The measurement duration of one carrier group is determined according to the ratio and a type of the shared measurement gap.

The type of the shared measurement gap includes:
a first-type shared measurement gap shared by the plurality of non-intra-frequency carriers; and/or,
a second-type shared measurement gap shared by the at least one intra-frequency carrier and the at least one non-intra-frequency carrier.

In an example, the carrier group includes at least one of the following:
a non-intra-frequency carrier group including one or more non-intra-frequency carriers;
an intra-frequency carrier group including the intra-frequency carriers; or
a hybrid carrier group including at least one intra-frequency carrier and at least one non-intra-frequency carrier.

In an example, the measurement duration of one carrier group is determined according to the ratio, the type of the shared measurement gap, and the duration of the shared measurement gap.

In some examples, the measurement duration occupied by one carrier group equals a product of the ratio occupied by the carrier group and the duration of the shared measurement gap in response to determining that the shared measurement gap is the first-type shared measurement gap.

In another example, the measurement duration occupied by one carrier group equals a product of the ratio occupied by the carrier group and the measurement duration of the non-intra-frequency carriers in response to determining that the shared measurement gap is the second-type shared measurement gap; where the measurement duration of the non-intra-frequency carriers is remaining duration obtained by subtracting the measurement duration of the intra-frequency carriers from the duration of the shared measurement gap.

In some examples, in response to determining that a plurality of non-intra-frequency carriers of one carrier group are required to be measured, the measurement duration determined according to the ratio occupied by the carrier group is shared by the plurality of non-intra-frequency carriers of the same carrier group.

In some examples, the shared measurement gap is the shared measurement gap shared by the intra-frequency carriers and the non-intra-frequency carriers, and the measurement configuration further includes:
second indication information indicating a measurement duration ratio of the intra-frequency carriers to the non-intra-frequency carriers.

In some examples, the second indication information includes:
second indexes indicating a first ratio of the measurement duration of the intra-frequency carriers to the shared measurement gap; and a sum of a second ratio and the first ratio is 1, and the second ratio is a ratio of the measurement duration of the non-intra-frequency carriers to the shared measurement gap.

In an example, the first indication information includes: third indexes, and one of the third indexes has a correspondence relation with a plurality of ratios; and a ratio occupied by one carrier group is a ratio of measurement duration of the carrier group to the shared measurement gap.

In an example, in response to determining that a plurality of non-intra-frequency carriers of one carrier group are required to be measured, the measurement duration determined according to the ratio occupied by the carrier group is shared by the plurality of non-intra-frequency carriers of the same carrier group.

A communication device is provided in an example of the disclosure. The communication device includes:
a memory configured to store a processor-executable instruction; and
processors connected to the memory separately; where
the processors are configured to execute a method for controlling a terminal and/or the method for processing information according to any technical solution above.

The processors may include various types of storage media. The storage media are non-transitory computer storage media that can continue remembering information stored after the communication device is powered off.

The communication device here includes: an access device, UE, or a core network device.

The processors may be connected to the memory through a bus, etc. and configured to read an executable program stored on the memory, for example, at least one of the methods shown in FIGS. 2, 4A-4B, and/or FIGS. 5-6.

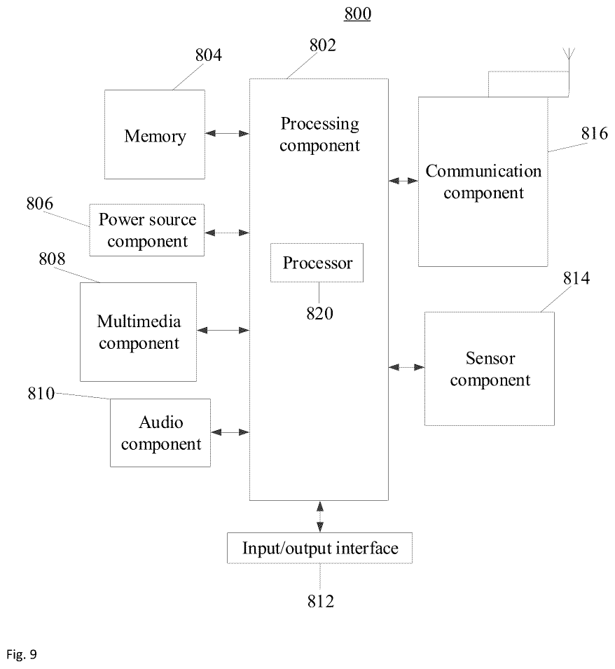

FIG. 9 is a block diagram of UE 800 shown according to an example. For example, the UE 800 may be a mobile phone, a computer, digital broadcast user equipment, a message transceiving device, a gaming console, a tablet device, a medical device, a fitness device, a personal digital assistant, etc.

With reference to FIG. 9, the UE 800 may include one or more of the following components: a processing component 802, a memory 804, a power source component 806, a multimedia component 808, an audio component 810, an input/output (I/O) interface 812, a sensor component 814, and a communication component 816.

Typically, the processing component 802 controls an overall operation of the UE 800, such as operations associated with display, telephone calls, data communication, a camera operation, and a recording operation. The processing component 802 may include one or more processors 820 to execute an instruction, so as to complete all or some steps of the method above. In addition, the processing component 802 may include one or more modules, so as to facilitate interactions between the processing component 802 and other components. For example, the processing component 802 may include a multimedia module, so as to facilitate the interaction between the multimedia component 808 and the processing component 802.

The memory 804 is configured to support the operations at the UE 800 by storing various types of data. Instances of these data include instructions of any application or method operated on the UE 800, contact data, phonebook data, messages, pictures, videos, etc. The memory 804 may be implemented through any type of volatile or non-volatile storage devices or their combinations, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk, and an optical disk.

The power source component 806 provides power for various components of the UE 800. The power source component 806 may include a power source management system, one or more power sources, and other components associated with power generation, management, and distribution for the UE 800.

The multimedia component 808 includes a screen that provides an output interface between the UE 800 and a user. In some examples, the screen may include a liquid crystal display (LCD) and a touch panel (TP). If including the touch panel, the screen may be implemented as a touch screen, so as to receive an input signal from the user. The touch panel includes one or more touch sensors, so as to sense touches, swipes, and gestures on the touch panel. The touch sensor may sense a boundary of a touch or swipe action and measure time and pressure associated with a touch or swipe operation. In some examples, the multimedia component 808 includes a front-facing camera and/or a rear-facing camera. When the UE 800 is in an operation mode, such as a photographing mode or a video mode, the front-facing camera and/or the rear-facing camera may receive external multimedia data. Each of the front-facing camera and the rear-facing camera may be a fixed optical lens system or have a focal length and an optical zoom capacity.

The audio component 810 is configured to output and/or input audio signals. For example, the audio component 810 includes a microphone (MIC) that is configured to receive external audio signals when the UE 800 is in the operation mode, such as a call mode, a recording mode, and a voice recognition mode. The audio signals received may be further stored on the memory 804 or transmitted via the communication component 816. In some examples, the audio component 810 further includes a speaker configured to output an audio signal.

The I/O interface 812 provides an interface between the processing component 802 and a peripheral interface module. The peripheral interface module above may be a keyboard, a click wheel, a button, etc. These buttons may include, but are not limited to, a home button, a volume button, a start button, and a lock button.

The sensor component 814 includes one or more sensors configured to provide state assessments for various aspects of the UE 800. For example, the sensor component 814 may detect an on/off state of the UE 800 and relative positioning of the components. For example, the components are a display and a keypad of the UE 800. The sensor component 814 may also detect a change in position of the UE 800 or one component of the UE 800, presence or absence of contact between the user and the UE 800, orientation or acceleration/deceleration of the UE 800, and a change in temperature of the UE 800. The sensor component 814 may include a proximity sensor configured to detect presence of nearby objects in the absence of any physical contact. The sensor component 814 may further include a light sensor, such as a complementary metal-oxide-semiconductor transistor (CMOS) or charge coupled device (CCD) image sensor configured to be used in imaging application. In some examples, the sensor component 814 may further include an acceleration sensor, a gyroscope sensor, a magnetic sensor, a pressure sensor, or a temperature sensor.

The communication component 816 is configured to facilitate wired or wireless communication between the UE 800 and other devices. The UE 800 may access a radio network based on a communication standard, for example, a wireless fidelity (WiFi) network, a 2nd generation (2G) network, or 3rd generation (3G) network, or their combinations. In an example, the communication component 816 receives a broadcast signal or broadcast related information from an external broadcast management system via a broadcast channel. In an example, the communication component 816 further includes a near field communication (NFC) module, so as to facilitate short-range communication. For example, the NFC module may be implemented on the basis of a radio frequency identification (RFID) technology, an infrared data association (IrDA) technology, an ultra wide band (UWB) technology, a Bluetooth (BT) technology, etc.

In an example, the UE 800 may be configured to execute the method above by being implemented by one or more application-specific integrated circuits (ASICs), digital signal processors (DSPs), digital signal processing devices (DSPDs), programmable logic devices (PLDs), field programmable gate array (FPGAs), controllers, microcontrollers, microprocessors, etc.

A non-transitory computer-readable storage medium including an instruction, such as a memory 804 including an instruction, is further provided in an example, where the instruction above may complete the method above by being executed by a processor 820 of the UE 800. For example, the non-transitory computer-readable storage medium may be an ROM, a random access memory (RAM), a compact disk read-only memory (CD-ROM), a magnetic tape, a floppy disk, an optical data storage device, etc.

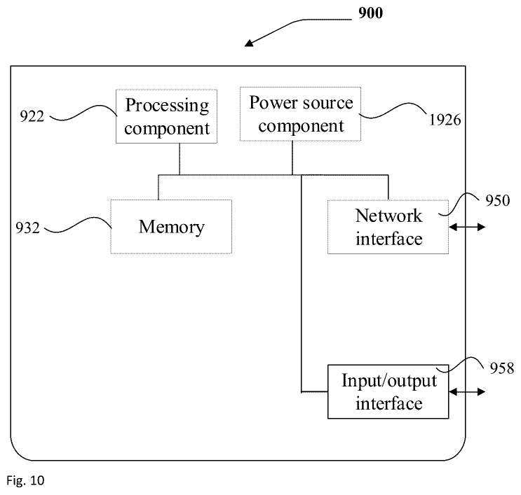

As shown in FIG. 10, a structure of an access device is shown according to an example of the disclosure. For example, a communication device 900 may be provided as a network side device. The communication device here may be the access device or the core network device above.

With reference to FIG. 10, the communication device 900 includes a processing component 922, and further includes one or more processors and memory resources represented by a memory 932 and configured to store an instruction executable by the processing component 922, for example, an application. The application stored in the memory 932 may include one or more modules, each of which corresponds to a set of instructions. In addition, the processing component 922 is configured to execute any method above applied to the access device, for example, the methods shown in FIGS. 2, 4A-4B, and/or 5-6 by executing the instruction.

The communication device 900 may further include a power source component 1926 configured to execute power source management of the communication device 900, a wired or wireless network interface 950 configured to connect the communication device 900 to a network, and an input/output (I/O) interface 958. The communication device 900 may operate based on an operating system stored on the memory 932, such as Windows Server™, Mac OS X™, Unix™, Linux™, and FreeBSD™.

Those skilled in the art will readily conceive of other embodiments of the disclosure after consideration of the description and practice of the invention disclosed here. The disclosure is intended to cover any variations, uses, or adaptive changes of the disclosure that follow the general principles of the disclosure and include common general knowledge or customary technical means in the art not disclosed in the disclosure. The description and the examples are merely deemed illustrative, and the true scope and spirit of the disclosure are indicated by the following claims.

It should be understood that the disclosure is not limited to the precise structures that have been described above and shown in the accompanying drawings, and that various modifications and changes can be made without departing from the scope of the disclosure. The scope of the disclosure is merely limited by the appended claims.

1. A method for processing information, performed by a base station and comprising:
transmitting a measurement configuration of a shared measurement gap, wherein the measurement configuration comprises first indication information, and wherein
the first indication information indicates a measurement duration ratio of a plurality of non-intra-frequency carriers.

2. The method according to claim 1, wherein the non-intra-frequency carriers comprise at least one of the following:
inter-frequency carriers;
inter-Radio Access Technology (RAT) carriers; or
carriers of different reference signals.

3. The method according to claim 1, wherein the first indication information comprises:
first indexes, and one of the first indexes has a correspondence relation with a plurality of ratios;
a ratio occupied by one carrier group is a ratio of measurement duration of the carrier group to measurement duration of the non-intra-frequency carriers;
the measurement duration of the non-intra-frequency carriers is duration of the shared measurement gap or remaining duration obtained by subtracting measurement duration of intra-frequency carriers from the duration of the shared measurement gap; and
one carrier group comprises one or more carriers.

4. The method according to claim 3, wherein the carrier group comprises at least one of the following:
a non-intra-frequency carrier group comprising one or more non-intra-frequency carriers;
an intra-frequency carrier group comprising the intra-frequency carriers; or
a hybrid carrier group comprising at least one intra-frequency carrier and at least one non-intra-frequency carrier.

5. The method according to claim 3, wherein
the measurement duration of one carrier group is determined according to the ratio, a type of the shared measurement gap, and the duration of the shared measurement gap.

6. The method according to claim 5, wherein the type of the shared measurement gap comprises:
a first-type shared measurement gap shared by the plurality of non-intra-frequency carriers; and/or
a second-type shared measurement gap shared by the at least one intra-frequency carrier and the at least one non-intra-frequency carrier.

7. The method according to claim 6, wherein the measurement duration occupied by one carrier group equals a product of the ratio occupied by the carrier group and the duration of the shared measurement gap in response to determining that the shared measurement gap is the first-type shared measurement gap.

8. The method according to claim 6, wherein the measurement duration occupied by one carrier group equals a product of the ratio occupied by the carrier group and the measurement duration of the non-intra-frequency carriers in response to determining that the shared measurement gap is the second-type shared measurement gap; and the measurement duration of the non-intra-frequency carriers is remaining duration obtained by subtracting the measurement duration of the intra-frequency carriers from duration of the shared measurement gap.

9. The method according to claim 6, wherein the shared measurement gap is the second-type shared measurement gap, and the measurement configuration further comprises:
second indication information indicating a measurement duration ratio of the intra-frequency carriers to the non-intra-frequency carriers.

10. The method according to claim 9, wherein the second indication information comprises:
second indexes indicating a first ratio of the measurement duration of the intra-frequency carriers to the shared measurement gap; and
a sum of a second ratio and the first ratio is 1, and the second ratio is a ratio of the measurement duration of the non-intra-frequency carriers to the shared measurement gap.

11. The method according to claim 1, wherein
the first indication information comprises: third indexes, and one of the third indexes has a correspondence relation with a plurality of ratios; and
a ratio occupied by one of carrier groups is a ratio of measurement duration of the carrier group to the shared measurement gap.

12. The method according to claim 3, wherein in response to determining that a plurality of carriers of one carrier group are required to be measured, measurement duration determined according to the ratio occupied by the carrier group is shared by the plurality of carriers of the same carrier group.

13. The method according to claim 1, wherein the measurement configuration further comprises at least one of the following:
a gap configuration indicating at least a time domain location of the shared measurement gap; or
a measurement object configuration indicating carriers to be measured.

14. The method according to claim 1, wherein transmitting the measurement configuration of a shared measurement gap comprises:
transmitting radio resource control (RRC) signaling comprising the measurement configuration;
or,
transmitting a media access control (MAC) control element (CE) comprising the measurement configuration.

15. A method for processing information, performed by user equipment (UE) and comprising:
receiving a measurement configuration of a shared measurement gap, wherein the measurement configuration comprises: first indication information; and wherein
the first indication information indicates a measurement duration ratio of a plurality of non-intra-frequency carriers.

16. (canceled)

17. The method according to claim 15, wherein the first indication information comprises:
first indexes, and one of the first indexes has a correspondence relation with a plurality of ratios;
the ratios are configured to determine measurement duration of carrier groups having a correspondence relation with the ratios;
a ratio occupied by one carrier group is a ratio of measurement duration of the carrier group to measurement duration of the non-intra-frequency carriers;
the measurement duration of the non-intra-frequency carriers is duration of the shared measurement gap or remaining duration obtained by subtracting measurement duration of intra-frequency carriers from the duration of the shared measurement gap; and
one carrier group comprises one or more carriers.

18-52. (canceled)

53. A communication device, comprising a processor, a transceiver, a memory, and an executable program stored on the memory and runnable by the processor, wherein the processor, when running the executable program, executes following steps of:
transmitting a measurement configuration of a shared measurement gap, wherein the measurement configuration comprises first indication information; and wherein
the first indication information indicates a measurement duration ratio of a plurality of non-intra-frequency carriers.

54. A computer storage medium, storing an executable program, wherein the executable program implements the method according to claim 1 after being performed by a processor.

55. A communication device, comprising a processor, a transceiver, a memory, and an executable program stored on the memory and runnable by the processor, wherein the processor executes the method according to claim 15 when running the executable program.

56. A computer storage medium, storing an executable program, wherein the executable program implements the method according claim 15 after being performed by a processor.
